(19) United States
(12) Patent Application Publication
(10) Pub. No.: US 2008/0066299 A1
(43) Pub. Date: Mar. 20, 2008

(54) Manufacturing method of a hydrogen separation membrane-electrolyte membrane assembly and a fuel cell provided with that assembly

(76) Inventor: Yasuhiro Izawa, Mishima-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/902,133

(22) Filed: Sep. 19, 2007

(30) Foreign Application Priority Data
Sep. 19, 2006 (JP) 2006-252282

(51) Int. Cl. H01M 8/10

(52) U.S. Cl. 29/623.1; 429/30

(57) ABSTRACT

A manufacturing method of a hydrogen separation membrane-electrolyte membrane assembly which includes the steps of applying a hydrogen permeation treatment at a predetermined temperature to a hydrogen separation membrane substrate, and forming an electrolyte membrane on the hydrogen separation membrane substrate after the hydrogen permeation treatment has been applied. At the time the electrolyte membrane is formed, the shape of the surface of the hydrogen separation membrane substrate has already changed. Therefore, the surface of the hydrogen separation membrane substrate will not easily deform even if hydrogen moves through the hydrogen separation membrane substrate after the electrolyte membrane is formed.

### INCORPORATION BY REFERENCE

The disclosure of Japanese Patent Application No. 2006-252282 filed on Sep. 19, 2006, including the specification, drawings and abstract is incorporated herein by reference in its entirety.

### BACKGROUND OF THE INVENTION

1. Field of the Invention

The invention relates to a manufacturing method of a hydrogen separation membrane-electrolyte membrane assembly and a fuel cell provided with that hydrogen separation membrane-electrolyte membrane assembly.

2. Description of the Related Art

A fuel cell is an apparatus that typically obtains electrical energy using hydrogen and oxygen as fuel. This fuel cell is very environmentally friendly and extremely energy efficient, which is why it is being widely developed as a future energy supply system.

Among the various type of fuel cells that exist, those that use solid electrolytes include polymer electrolyte membrane fuel cells, solid oxide fuel cells, and hydrogen separation membrane fuel cells. A hydrogen separation membrane fuel cell is a fuel cell provided with a elaborate hydrogen separation membrane. This elaborate hydrogen separation membrane is a layer formed of a metal through which hydrogen can permeate and also functions as an anode. A hydrogen separation membrane fuel cell has a structure in which a proton-conducting electrolyte is laminated onto this hydrogen separation membrane. Hydrogen supplied to the hydrogen separation membrane is converted into protons which move through the proton conducting electrolyte and combine with oxygen at a cathode, thus generating electricity (see Japanese Patent Application Publication No. 2004-146337 (JP-A-2004-146337), for example).

However, with the technology described in JP-A-2004-146337, protons permeating the hydrogen separation membrane when the fuel cell is operating may cause the shape of the boundary face of the hydrogen separation membrane and the electrolyte membrane to change, which may cause boundary peeling between the hydrogen separation membrane and the electrolyte membrane.

### SUMMARY OF THE INVENTION

This invention thus provides a manufacturing method of a hydrogen separation membrane-electrolyte membrane assembly that is able to suppress boundary peeling between the hydrogen separation membrane and the electrolyte membrane, as well as provides a manufacturing method of a fuel cell provided with this hydrogen separation membrane-electrolyte membrane assembly.

A first aspect of the invention relates to a manufacturing method of a hydrogen separation membrane-electrolyte membrane assembly that includes the steps of applying a hydrogen permeation treatment at a predetermined temperature to a hydrogen separation membrane substrate, and then forming an electrolyte membrane on the hydrogen separation membrane substrate. In the manufacturing method of a hydrogen separation membrane-electrolyte membrane assembly according to the invention, the hydrogen permeation treatment is applied at a predetermined temperature to the hydrogen separation membrane substrate before the electrolyte membrane is formed so the shape of the surface of the hydrogen separation membrane substrate is already changed by the time the electrolyte membrane is formed. That is, the shape of the surface of the hydrogen separation membrane substrate is stable. Accordingly, the surface of the hydrogen separation membrane substrate will not easily deform even if hydrogen moves through the hydrogen separation membrane substrate after the electrolyte membrane is formed. As a result, boundary peeling between the hydrogen separation membrane substrate and the electrolyte membrane can be suppressed.

The predetermined temperature may be a temperature that exceeds a hydrogen embrittlement temperature of a metal from which the hydrogen separation membrane substrate is formed. In this case, hydrogen embrittlement during the hydrogen permeation treatment can be suppressed. Also, the predetermined temperature may be equal to or greater than a recrystallization temperature of a metal from which the hydrogen separation membrane substrate is formed. In this case, the movement of imperfections in the hydrogen separation membrane substrate can be promoted. Accordingly, the shape of the surface of the hydrogen separation membrane substrate is able to easily change during the hydrogen permeation treatment. Furthermore, the predetermined temperature may be equal to or greater than an operating temperature of the hydrogen separation membrane-electrolyte membrane assembly. In this case, peeling of the hydrogen separation membrane substrate and the electrolyte membrane when the hydrogen separation membrane-electrolyte membrane assembly is operating can be suppressed.

The electrolyte membrane may be formed on a surface, from among both surfaces of the hydrogen separation membrane substrate, on a side from which hydrogen exits in the hydrogen permeation treatment. Here, imperfections in the hydrogen separation membrane substrate tend to move in the direction in which the hydrogen permeates the hydrogen separation membrane substrate such that the shape of the surface on the side from which hydrogen exits the hydrogen separation membrane substrate easily changes. Accordingly, by forming the electrolyte membrane on the surface on the side from which hydrogen exits in the hydrogen permeation treatment of the hydrogen separation membrane substrate, deformation during use of the hydrogen separation membrane substrate can be further suppressed.

The hydrogen permeation treatment may be applied to the hydrogen separation membrane substrate by causing the hydrogen to permeate the hydrogen separation membrane substrate by creating a hydrogen partial pressure difference between an atmosphere on one side of the hydrogen separation membrane substrate and an atmosphere on the other side of the hydrogen separation membrane substrate. In this case, the hydrogen partial pressure differences acts as a driving force that causes the hydrogen to permeate the hydrogen separation membrane substrate.

A second aspect of the invention relates to a manufacturing method of a fuel cell that includes the step of forming a cathode on the electrolyte membrane of the hydrogen separation membrane-electrolyte membrane assembly according to the first aspect. In the manufacturing method of a fuel cell according to the invention, the shape of the surface of the hydrogen separation membrane substrate is already changed by the time the electrolyte membrane is formed. That is, the shape of the surface of the hydrogen separation membrane substrate is stable. Accordingly, the surface of the hydrogen separation membrane substrate will not easily deform even when the completed fuel cell generates power. As a result, boundary peeling between the hydrogen separation membrane substrate and the electrolyte membrane can be suppressed.

This invention makes it possible to suppress boundary peeling between the hydrogen separation membrane and the electrolyte membrane.

### BRIEF DESCRIPTION OF THE DRAWINGS

The foregoing and further objects, features and advantages of the invention will become apparent from the following description of exemplary embodiments with reference to the accompanying drawings, wherein like numerals are used to represent like elements and wherein:

FIGS. 1A to 1D are views illustrating the flow of the manufacturing method of a hydrogen separation membrane-electrolyte membrane assembly and a fuel cell provided with this hydrogen separation membrane-electrolyte membrane assembly according to an example embodiment of the invention;

FIGS. 2A to 2C are views illustrating the details of a hydrogen permeation treatment and a hydrogen treatment; and

FIGS. 3A to 3H are photographs showing the results of the hydrogen permeation treatment and the hydrogen treatment.

### DETAILED DESCRIPTION OF THE EMBODIMENTS

### Example Embodiment

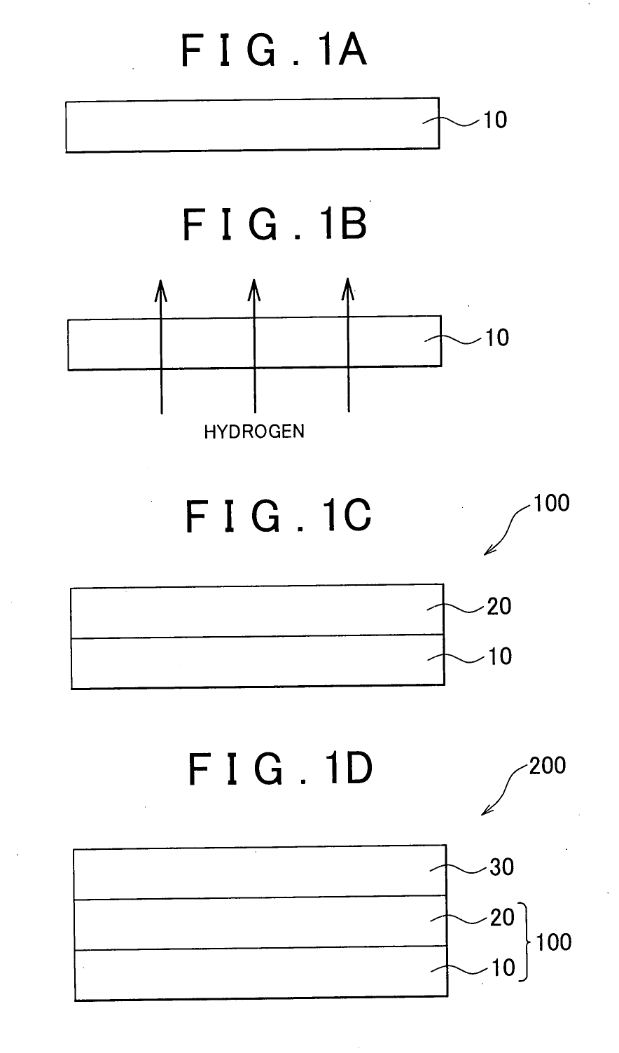

FIGS. 1A to 1D are views illustrating the flow of the manufacturing method of a hydrogen separation membrane-electrolyte membrane assembly and a fuel cell provided with this hydrogen separation membrane-electrolyte membrane assembly according to an example embodiment of the invention. As shown in FIG. 1A, first a hydrogen separation membrane substrate 10 functions as both an anode to which fuel gas is supplied and a base which supports and reinforces an electrolyte membrane 20 which will be described later.

The hydrogen separation membrane substrate 10 is formed of a hydrogen permeable layer. The material of which the hydrogen separation membrane substrate 10 is formed is not particularly limited as long as it is hydrogen permeable and conductive. The hydrogen separation membrane substrate 10 may be made of a metal such as Pd (palladium), V (vanadium), Ta (tantalum), or Nb (niobium), or an alloy of any of these. Also, the hydrogen separation membrane substrate 10 may also be a structure in which a membrane of palladium or a palladium alloy or the like that can separate hydrogen is formed on the surface, of the two surfaces of the hydrogen permeable layer, on the side on which the electrolyte membrane 20, which will be described later, is formed. The thickness of the hydrogen separation membrane substrate 10 is approximately 5 μm to 100 μm, inclusive, for example. The hydrogen separation membrane substrate 10 may be a self-supported film or it may be supported by a porous base metal.

Next, as shown in FIG. 1B, hydrogen permeation treatment is applied to the hydrogen separation substrate 10. One example of this treatment involves creating a hydrogen partial pressure difference between the atmosphere on one side of the hydrogen separation membrane substrate 10 and the atmosphere on the other side of the hydrogen separation membrane substrate 10. In this case, the hydrogen partial pressure difference acts as the driving force that causes hydrogen to permeate the hydrogen separation membrane substrate 10. The hydrogen partial pressure difference can be created by, for example, making the atmosphere on one side of the hydrogen separation membrane substrate 10 a hydrogen atmosphere and making the atmosphere on the other side of the hydrogen separation membrane substrate 10 an inert gas atmosphere such as a nitrogen atmosphere. When the hydrogen permeates the hydrogen separation membrane substrate 10, the shape of the surface of the hydrogen separation membrane substrate 10 changes. This change is thought to be the result of imperfections and the like in the hydrogen separation membrane substrate 10 moving as the hydrogen permeates the hydrogen separation membrane substrate 10. Incidentally, in the process shown in FIG. 1B, hydrogen may also be made to permeate the hydrogen separation membrane substrate 10 by electrical treatment.

Next, the electrolyte membrane 20 is formed on the hydrogen separation membrane substrate 10, as shown in FIG. 1C. The method by which the electrolyte membrane 20 is formed is not particularly limited. For example, the PLD method or the like can be used. The electrolyte membrane 20 is made of a proton conductive electrolyte. A solid oxide electrolyte of perovskite, for example, can be used as the electrolyte membrane 20. The thickness of the electrolyte membrane 20 is approximately 0.2 μm to 5 μm, inclusive.

A hydrogen separation membrane-electrolyte membrane assembly 100 is completed by the process described above. Next, as shown in FIG. 1D, a cathode 30 is formed on the electrolyte membrane 20. The cathode 30 is an electrode to which oxidant gas is supplied and may be formed of conductive material such as platinum-carrying carbon. A fuel cell 200 is completed by this process.

Here, a general outline of the operation of the fuel cell 200 will be described. First, a fuel gas containing hydrogen is supplied to the hydrogen separation membrane substrate 10. The hydrogen molecules in the fuel gas become atomic hydrogen which permeates the hydrogen separation membrane substrate 10. The hydrogen that has permeated the hydrogen separation membrane substrate 10 then splits into protons and electrons at the boundary face of the hydrogen separation membrane substrate 10 and the electrolyte membrane 20. The protons produced at the boundary face of the hydrogen separation membrane substrate 10 and the electrolyte membrane 20 are conducted through the electrolyte membrane 20 to the cathode 30.

Meanwhile, oxidant gas containing oxygen is supplied to the cathode 30. In the cathode 30, water is produced and power generated from the oxygen in the oxidant gas and the protons that have reached the cathode 30. The generated power is recovered via a separator, not shown. The fuel cell 200 generates power according to this operation.

The shape of the surface of the hydrogen separation membrane substrate 10 has already changed by the time the fuel cell 200 operates. That is, the shape of the surface of the hydrogen separation membrane substrate 10 is stable when the fuel cell 200 operates. Therefore, even if hydrogen moves through the hydrogen separation membrane substrate 10 as the fuel cell 200 generates power, the shape of the hydrogen separation membrane substrate 10 does not easily deform. As a result, boundary peeling between the hydrogen separation membrane substrate 10 and the electrolyte membrane 20 can be suppressed. Here, the hydrogen permeation treatment and the hydrogen treatment differ because in the hydrogen treatment, the entire hydrogen separation membrane substrate is exposed to a hydrogen atmosphere so hydrogen does not permeate the hydrogen separation membrane substrate. Therefore, in the hydrogen treatment, imperfections and the like in the hydrogen separation membrane substrate tend not to move.

Incidentally, the temperature of the hydrogen separation membrane substrate 10 in the hydrogen permeation treatment shown in FIG. 1B is not particularly limited, but it is preferable that it exceed the hydrogen embrittlement temperature of the metal from which the hydrogen separation membrane substrate 10 is made. This is because the hydrogen permeation treatment may cause hydrogen embrittlement to occur in the hydrogen separation membrane substrate 10. As an example, the hydrogen embrittlement temperature of the hydrogen separation membrane substrate 10 is approximately 300° C. when palladium is used for the hydrogen separation membrane substrate 10.

Also, the temperature of the hydrogen separation membrane substrate 10 in the hydrogen permeation treatment shown in FIG. 1B is preferably equal to or greater than the recrystallization temperature of the metal from which the hydrogen separation membrane substrate 10 is made. This is because in this case imperfections and the like in the hydrogen separation membrane substrate 10 tend to move easily. As an example, the recrystallization temperature of the hydrogen separation membrane substrate 10 is approximately 250° C. if palladium is used for the hydrogen separation membrane substrate 10. The hierarchical relationship of the hydrogen embrittlement temperature and the recrystallization temperature differs depending on the material. If the hydrogen permeation treatment is applied at a higher temperature than both the hydrogen embrittlement temperature and the recrystallization temperature, hydrogen embrittlement of the hydrogen separation membrane substrate 10 can be suppressed while movement of the imperfections and the like is promoted.

Furthermore, the temperature of the hydrogen separation membrane substrate 10 in the hydrogen permeation treatment shown in FIG. 1B is more preferably equal to or higher than the operating temperature of the hydrogen separation membrane-electrolyte membrane assembly 100, i.e., equal to or higher than the operating temperature of the fuel cell 200. This is because applying the hydrogen permeation treatment at a temperature that is equal to or higher than the operating temperature of the fuel cell 200 enables deformation of the hydrogen separation membrane substrate 10 while the fuel cell 200 is operating to be further suppressed. The operating temperature of the fuel cell 200 is approximately 400° C., for example.

Also, the electrolyte membrane 20 may be formed on either side of the hydrogen separation membrane substrate 10, but it is preferably formed on the side from which the hydrogen exits the hydrogen separation membrane substrate 10 in the hydrogen permeation treatment. This is because imperfections in the hydrogen separation membrane substrate 10 tend to move in the direction in which the hydrogen permeates so the shape of the surface of the side from which the hydrogen exits the hydrogen separation membrane substrate 10 tends to deform. That is, forming the electrolyte membrane 20 on the side from which the hydrogen exits the hydrogen separation membrane substrate 10 during the hydrogen permeation treatment enables deformation of the hydrogen separation membrane substrate 10 when the fuel cell 200 is generating power to be further suppressed.

Hydrogen permeation treatment was applied to the hydrogen separation membrane substrate according to the foregoing example embodiment and the change in the shape of the surface of the hydrogen separation membrane substrate after the hydrogen permeation treatment was applied was inspected. The method used and the results obtained will hereinafter be described.

### First Example

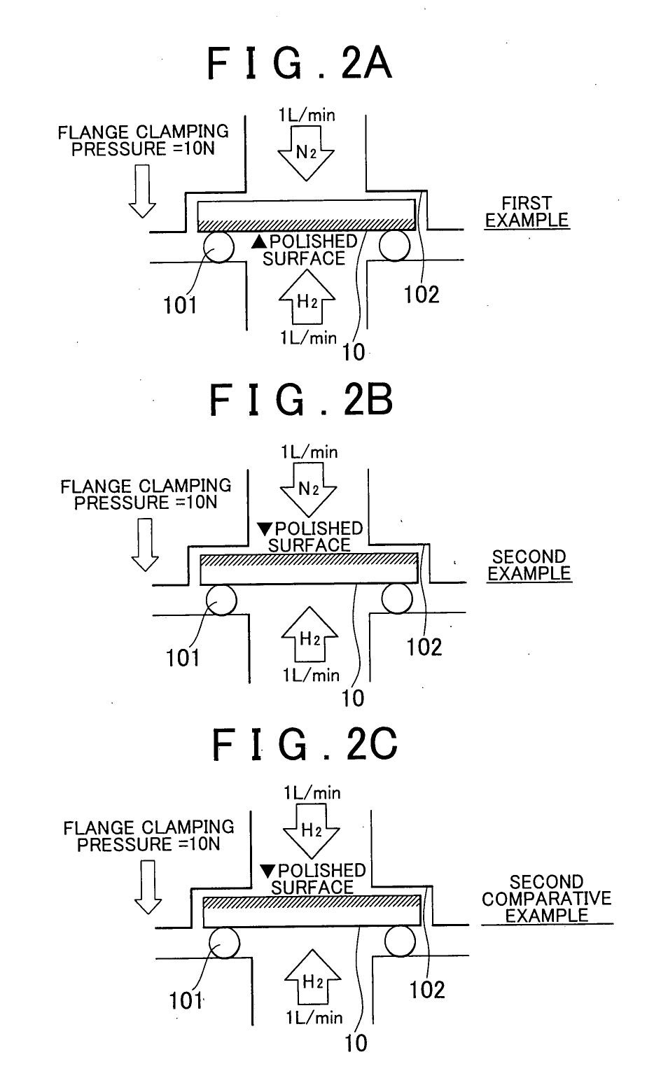

In a first example, a hydrogen permeation treatment was applied to the hydrogen separation membrane substrate 10. FIG. 2A shows the details of the hydrogen permeation treatment. In the hydrogen permeation treatment shown in FIG. 2A, a hydrogen separation membrane substrate 10 was used which was made from palladium 80 μm thick. The lower surface of this hydrogen separation membrane substrate 10 was polished. As shown in FIG. 2A, a metal gasket 101 was arranged on a peripheral edge portion of the lower surface of the hydrogen separation membrane substrate 10, and a flange 102 was arranged on a peripheral edge portion of the upper surface of the hydrogen separation membrane substrate 10. A force of 10 N was then applied to the hydrogen separation membrane substrate 10 from the flange 102 such that the atmosphere on the upper surface side of the hydrogen separation membrane substrate 10 was sealed from the atmosphere on the lower surface side of the hydrogen separation membrane substrate 10.

Next, 1 L/min of nitrogen gas was supplied to the upper surface side of the hydrogen separation membrane substrate 10 and 1 L/min of hydrogen gas was supplied to the lower surface side of the hydrogen separation membrane substrate 10 such that hydrogen was made to permeate the hydrogen separation membrane substrate 10 from the lower surface side to the upper surface side. In this state, the hydrogen separation membrane substrate 10 was kept at a temperature of 400° C. for four hours. Incidentally, the polishing was performed to make it easier to see the shape of the surface.

### Second Example

In a second example, a hydrogen permeation treatment was applied just as in the first example. FIG. 2B shows the details of the hydrogen permeation treatment. The second example differs from the first example in that the upper surface of the hydrogen separation membrane substrate 10 is polished instead of the lower surface.

### First Comparative Example

In a first comparative example, a hydrogen separation membrane substrate 10 was prepared without a hydrogen permeation treatment being applied. The hydrogen separation membrane substrate 10 according to this first comparative example has a structure similar to that of the hydrogen separation membrane substrate 10 according to the second example, with the upper surface being polished.

### Second Comparative Example

In a second comparative example, a hydrogen treatment was applied to the hydrogen separation membrane substrate 10. FIG. 2C shows the details of the hydrogen treatment. The second comparative example differs from the first example in that the upper surface of the hydrogen separation membrane substrate 10 is polished and 1 L/min of hydrogen gas is supplied to both the upper and lower surface sides.

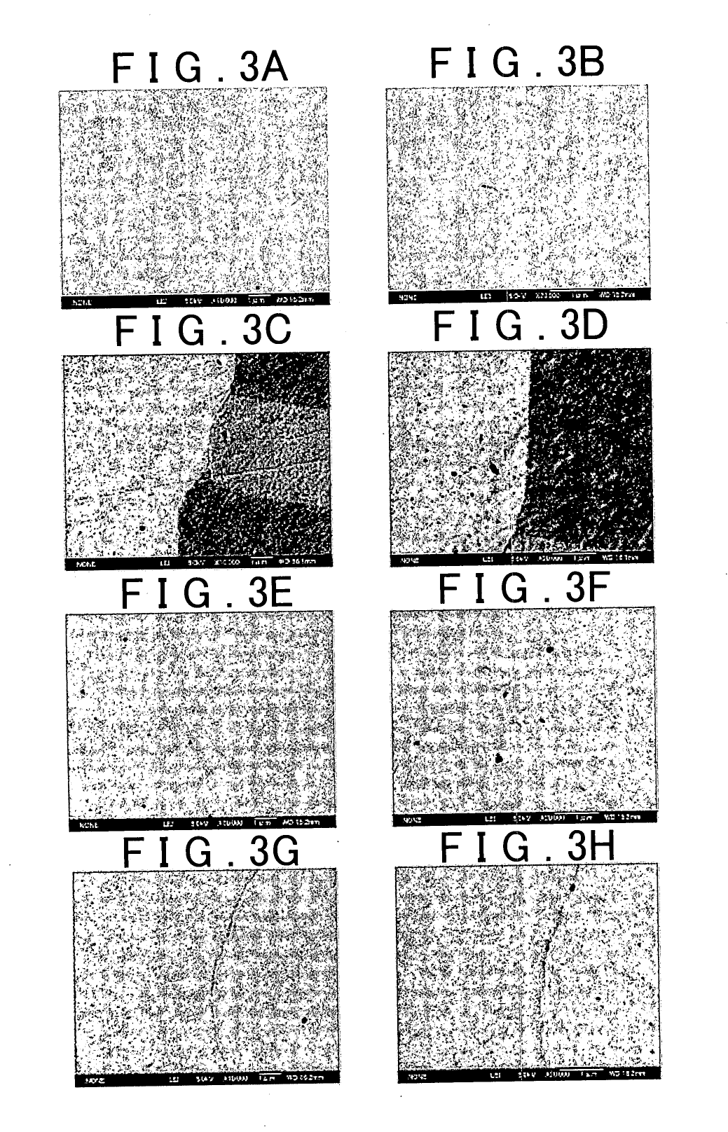

(Analysis) The surfaces of the hydrogen separation membrane substrates 10 according to the first and second examples and the first and second comparative examples were viewed using SEM. The results are shown in FIGS. 3A to 3H. FIGS. 3A and 3B show the surface of the lower side of the hydrogen separation membrane substrate 10 according to the first example, and FIGS. 3C and 3D show the surface of the upper side of the hydrogen separation membrane substrate 10 according to the second example. FIGS. 3E and 3F show the surface of the upper side of the hydrogen separation membrane substrate 10 according to the first comparative example, and FIGS. 3G and 3H show the surface of the upper side of the hydrogen separation membrane substrate 10 according to the second comparative example. Incidentally, the magnification in the photographs shown in FIGS. 3A, 3C, 3E, and 3G is 10,000× and the magnification in the photographs shown in FIGS. 3B, 3D, 3F, and 3H is 20,000×.

As shown in FIGS. 3E and 3F, the surface of the hydrogen separation membrane substrate 10 according to the first comparative example is relatively flat. This is thought to be because neither the hydrogen permeation treatment nor the hydrogen treatment was applied. Next, as shown in FIGS. 3G and 3H, the shape of the surface of the hydrogen separation membrane substrate 10 according to the second comparative example has changed slightly but is still relatively flat. This is thought to be because hydrogen did not permeate the hydrogen separation membrane substrate 10.

In contrast, as shown in FIGS. 3A and 3B, the surface of the lower side of the hydrogen separation membrane substrate 10 according to the first example has many tiny holes in it. This is thought to be because the imperfections and the like in the hydrogen separation membrane substrate 10 moved to the surface as the hydrogen permeated the hydrogen separation membrane substrate 10. Also, as shown in FIGS. 3C and 3D, the surface on the upper side of the hydrogen separation membrane substrate 10 according to the second example has even more tiny holes in it than the hydrogen separation membrane substrate 10 of the first example. This is thought to be because the imperfections in the hydrogen separation membrane substrate 10 moved in the direction in which the hydrogen permeated the hydrogen separation membrane substrate 10.

Incidentally, although difficult to discern in the photographs shown in FIGS. 3A to 3H, when enlarged microscopic images are viewed with the naked eye, polishing marks or scratches can be seen on the surfaces in the first and second comparative examples, but otherwise the surfaces are smooth. In contrast, the surfaces in the first and second examples appear pocked and pitted and have many holes in them.

Accordingly, it is evident that tiny holes are created in the surface of the hydrogen separation membrane substrate 10, in particular, many tiny holes are created in the surface on the side from which hydrogen exits the hydrogen separation membrane substrate 10, as a result of the hydrogen permeation treatment. This indicates that the surface of the hydrogen separation membrane substrate 10 does not deform (i.e., the shape of the surface does not change) easily even if hydrogen still moves through the hydrogen separation membrane substrate 10 when power is generated. Therefore, forming the electrolyte membrane 20 on the hydrogen separation membrane substrate 10 to which hydrogen permeation treatment has been applied enables peeling between the hydrogen separation membrane substrate 10 and the electrolyte membrane 20 to be suppressed.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

What is claimed is:

1. A manufacturing method of a hydrogen separation membrane-electrolyte membrane assembly, comprising:
applying a hydrogen permeation treatment at a predetermined temperature to a hydrogen separation membrane substrate; and
forming an electrolyte membrane on the hydrogen separation membrane substrate after the hydrogen permeation treatment has been applied.

2. The manufacturing method according to claim 1, wherein the predetermined temperature is a temperature that exceeds a hydrogen embrittlement temperature of a metal from which the hydrogen separation membrane substrate is formed.

3. The manufacturing method according to claim 1, wherein the predetermined temperature is equal to or greater than a recrystallization temperature of a metal from which the hydrogen separation membrane substrate is formed.

4. The manufacturing method according to claim 1, wherein the predetermined temperature is equal to or greater than an operating temperature of the hydrogen separation membrane-electrolyte membrane assembly.

5. The manufacturing method according to claim 1, wherein the electrolyte membrane is formed on a surface, from among both surfaces of the hydrogen separation membrane substrate, on a side from which hydrogen exits in the hydrogen permeation treatment.

6. The manufacturing method according to claim 1, wherein the hydrogen permeation treatment is applied to the hydrogen separation membrane substrate by causing hydrogen to permeate the hydrogen separation membrane substrate by creating a hydrogen partial pressure difference between an atmosphere on one side of the hydrogen separation membrane substrate and an atmosphere on the other side of the hydrogen separation membrane substrate.

7. A manufacturing method of a fuel cell, comprising:
forming a cathode on the electrolyte membrane of the hydrogen separation membrane-electrolyte membrane assembly manufactured by the manufacturing method according to claim 1.
